(19) United States
(12) Patent Application Publication
(10) Pub. No.: US 2017/0280400 A1
(43) Pub. Date: Sep. 28, 2017

(54) METHOD FOR CONTROLLING STANDBY POWER CONSUMPTION OF A MOBILE TERMINAL, ELECTRONIC DEVICE AND STORAGE MEDIUM

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Jianfei XIAO, Beijing (CN)

(21) Appl. No.: 15/239,107

(22) Filed: Aug. 17, 2016

Related U.S. Application Data
(63) Continuation of application No. PCT/CN2016/088828, filed on Jul. 6, 2016.

(30) Foreign Application Priority Data
Mar. 24, 2016 (CN) 2016101736581

(51) Int. Cl. H04W 52/42; H04W 76/04; H04W 72/04

(52) U.S. Cl. CPC H04W 52/42; H04W 72/0446; H04W 76/048

(57) ABSTRACT

Disclosed are a method and device for controlling standby power consumption of a mobile terminal. The method comprises: in a first cycle of discontinuous reception, obtaining, by way of searching adjacent cells, a control channel allocation list of a first adjacent cell for the first network mode and a control channel allocation list of a second adjacent cell for the second network mode; generating a list of shared channels according to the same channels within the said control channel allocation list of the first adjacent cell and the said control channel allocation list of the second adjacent cell; and in a second cycle of discontinuous reception, re-obtaining, by way of searching adjacent cells, the said control channel allocation list of the first adjacent cell and updating the said control channel allocation list of the second adjacent cell according to the said control channel allocation list of the first adjacent cell.

### CROSS REFERENCE TO RELATED APPLICATIONS

The present application is a continuation of PCT application which has an application number of PCT/CN2016/088828 and was filed on Jul. 6, 2016. This application is based upon and claims priority to Chinese Patent Application NO.201610173658.1, titled “method and device for controlling standby power consumption of mobile terminal”, filed on Mar. 24, 2016 with the State Intellectual Property Office of People's Republic of China, the entire contents of which are incorporated herein by reference.

### TECHNICAL FIELD

The disclosure relates to the technical field of mobile communication, and in particular to a method and device for controlling standby power consumption of a mobile terminal.

### BACKGROUND

The dual-card-dual-standby (DSDS) technology has been widely applied in mobile terminals. A mobile terminal can simultaneously use two different subscriber identity module (SIM) cards to stay standby and make phone calls. Particularly, with the development of the communication technology, different types of network modes of communication network can coexist. In order to apply different network modes, mobile terminals also have a dual-mode or multi-mode operation mode. That is, the mobile terminal may use two or more different network modes of communication network to communicate according to the dual-card-dual-standby technology, thereby fulfilling users' demands.

The dual-card-dual-standby mobile terminal offers convenience to users. However, the dual-card-dual-standby mobile terminal still has some problems relative to a single-card mobile terminal. One key problem is short standby time. In a standby mode, since two baseband processors, two radio frequency antennas and two modems adapting to different networks are provided in the dual-card-dual-standby mobile terminal, the dual-card-dual-standby mobile terminal consumes more power as compared with a single-card mobile terminal.

In order to solve the problem, the industry has been seeking a corresponding solution. For example, a Chinese patent application for invention titled “Dual-mode mobile phone and switch method thereof” (publication number: CN101291474A) discloses a solution for reducing power consumption of a mobile device. The main technical features of the application is that: it is switched between two modes by using interruption between two communication modules, thereby reducing requirements of the main frequency or the division frequency of CPU and reducing power consumption by freely controlling the sleep state of a mobile phone.

However, the above-mentioned existing dual-mode mobile control method requires the underlying protocol of communication module; hence there is a problem as to compatibility. In addition, every time when it switches to a new mode, the dual-mode mobile phone repeats searching of adjacent cells, thereby resulting in extra power consumption. Therefore, it is hoped to provide a new method and device for controlling standby power consumption of a mobile terminal, to further improve compatibility and reduce power consumption.

### SUMMARY

An object of the disclosure is to provide a method and device for controlling standby power consumption of a mobile terminal, whereby during standby unnecessary adjacent cell search is reduced by adopting a list of shared channels, thereby reducing standby power consumption of the mobile terminal.

According to an aspect of the disclosure, a method for controlling standby power consumption of a mobile terminal is provided, where the said mobile terminal operates in a first network mode and a second network mode, and the said method comprises: in a first cycle of discontinuous reception obtaining, by way of searching adjacent cells, a control channel allocation list of a first adjacent cell for the first network mode and a control channel allocation list of a second adjacent cell for the second network mode; generating a list of shared channels according to the same channels within the said control channel allocation list of the first adjacent cell and the said control channel allocation list of the second adjacent cell; and re-obtaining, by way of searching adjacent cells, the said control channel allocation list of the first adjacent cell and updating the said control channel allocation list of the second adjacent cell according to the said control channel allocation list of the first adjacent cell in a second cycle of discontinuous reception.

Optionally, the said first cycle of discontinuous reception includes a first time-slot and a second time-slot, and the said control channel allocation list of the first adjacent cell and the said control channel allocation list of the second adjacent cell are obtained respectively on the first time-slot and the second time-slot of the said first cycle of discontinuous reception; and the said second cycle of discontinuous reception includes a first time-slot and a second time-slot, and the said control channel allocation list of the first adjacent cell is re-obtained on the first time-slot of the said second cycle of discontinuous reception and the said control channel allocation list of the second adjacent cell is updated on the second time-slot of the said second cycle of discontinuous reception.

Optionally, in the said first cycle of discontinuous reception, the method further comprises: measuring signal strength of multiple channels in the said first adjacent cell control channel and sorting out the multiple channels in the said first adjacent cell control channel according to the signal strength, and measuring signal strength of multiple channels in the second adjacent cell control channel and sorting out the multiple channels in the second adjacent cell control channel according to the signal strength; and in the second cycle of discontinuous reception, re-measuring signal strength of multiple channels in the first adjacent cell control channel and sorting out the multiple channels in the first adjacent cell control channel according to the signal strength.

Optionally, updating the said control channel allocation list of the second adjacent cell according to the said control channel allocation list of the first adjacent cell comprises: where the said list of shared channels is effective, updating, in the said second cycle of discontinuous reception, the said control channel allocation list of the second adjacent cell by using the channel information of the said control channel allocation list of the first adjacent cell; or where the said list of shared channels is ineffective, re-obtaining, in the said second cycle of discontinuous reception, the said control channel allocation list of the second adjacent cell by searching adjacent cells.

Optionally, updating the said control channel allocation list of the second adjacent cell according to the said control channel allocation list of the first adjacent cell further comprises: measuring signal strength of multiple channels in the said first adjacent cell control channel and sorting out the multiple channels in the said first adjacent cell control channel according to the signal strength; and determining whether the said list of shared channels is effective according to the re-obtained said control channel allocation list of the first adjacent cell and the measured signal strength.

Optionally, determining whether the said list of shared channels is effective includes: comparing the re-obtained said first adjacent cell control channel with the said list of shared channels; and comparing the said measured signal strength with a predetermined threshold value, wherein the said list of shared channels is determined to be effective if the said re-obtained control channel allocation list of the first adjacent cell includes a shared channel from the said list of shared channels and signal strength of at least one shared channel from the said shared channels is greater than the said predetermined threshold value.

Optionally, updating the said control channel allocation list of the second adjacent cell according to the said control channel allocation list of the first adjacent cell comprises: using the said list of shared channels as the said control channel allocation list of the second adjacent cell.

Optionally, updating the said control channel allocation list of the second adjacent cell according to the said control channel allocation list of the first adjacent cell comprises: updating, for the at least one of the said shared channels, information of the corresponding channels in the said control channel allocation list of the second adjacent cell by using information of the at least one of the said shared channels.

Optionally, the said first network mode and the said second network mode are selected respectively from one of the 2G 3G and 4G mobile communication networks.

Optionally, the said first cycle of discontinuous reception and the said second cycle of discontinuous reception are standby cycles of the said mobile terminal.

According to another aspect of an embodiment of the present disclosure, an electronic device is provided, which comprises: at least one processor; and a memory communicably connected with the said at least one processor; wherein, the said memory stores instructions executable by the said at least one processor, wherein execution of the instructions by the said at least one processor causes the at least one processor to: in a first cycle of discontinuous reception, obtain, by way of searching adjacent cells, a control channel allocation list of a first adjacent cell for the first network mode and a control channel allocation list of a second adjacent cell for the second network mode; generate a list of shared channels according to the same channels within the said control channel allocation list of the first adjacent cell and the said control channel allocation list of the second adjacent cell; and in a second cycle of discontinuous reception, re-obtain, by way of searching adjacent cells, the said control channel allocation list of the first adjacent cell and update the said control channel allocation list of the second adjacent cell according to the said control channel allocation list of the first adjacent cell.

According to another aspect of an embodiment of the present disclosure, a non-transitory computer-readable storage medium, wherein the said non-transitory computer-readable storage medium can store computer-executable instructions, the said computer-executable instructions are used to: in a first cycle of discontinuous reception, obtain, by way of searching adjacent cells, a control channel allocation list of a first adjacent cell for the first network mode and a control channel allocation list of a second adjacent cell for the second network mode; generate a list of shared channels according to the same channels within the said control channel allocation list of the first adjacent cell and the said control channel allocation list of the second adjacent cell; and in a second cycle of discontinuous reception, re-obtain, by way of searching adjacent cells, the said control channel allocation list of the first adjacent cell and update the said control channel allocation list of the second adjacent cell according to the said control channel allocation list of the first adjacent cell.

In the present application, working flows of independent standby of the dual-card-dual-standby mobile terminal in two network modes are integrated, removing sub-processes and thereby optimizing the standby power consumption.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 schematically illustrates a flowchart of a method for controlling standby power consumption in accordance with an embodiment of the disclosure;

FIG. 2 schematically illustrates a block diagram of principles of a device for controlling standby power consumption in accordance with an embodiment of the disclosure;

FIG. 3 schematically illustrates a schematic diagram in which a first SIM card and a second SIM card operate on different time-slots;

FIG. 4 schematically illustrates a current waveform graph of a method for controlling standby power consumption in accordance with prior arts during a wakeup period of the second SIM card;

FIG. 5 schematically illustrates a current waveform graph of a method for controlling standby power consumption in accordance with an embodiment of the disclosure during a wakeup period of the second SIM card; and

FIG. 6 illustrates the hardware structure of the device executing the method of controlling standby power consumption prescribed by the present invention.

### DETAILED DESCRIPTION

Hereinafter exemplary embodiments of the disclosure are elaborated in detail with reference to the drawings. Although the drawings show exemplary embodiments of the disclosure, it should be understood that the disclosure may be implemented in various forms and is not limited by the embodiments herein. In contrast, the embodiments are provided such that the disclosure can be understood more thoroughly and the scope of the disclosure can be fully conveyed to those skilled in the art.

The application scene of the disclosure is a dual-card-dual-standby mobile terminal, which includes but not limited to a mobile phone, a tablet, a laptop or a smart household appliance and so on, supporting access to multiple networks. In order to clearly elaborate technical solutions of the present application, it is exemplified by a dual-card-dual-standby mobile phone.

For example, nowadays most of dual-card-dual-standby mobile phones have the following configuration: a first SIM card SIM1 supporting 3G/4G+2G (i.e. it supports both the packet service and the voice call service), and a second SIM card SIM2 supporting 2G (i.e., it only supports the voice call service).

In general, where a mobile phone is in a standby mode, a modem module of the mobile phone is mainly configured to:

1, remain within a cell of the best signal quality and perform searching of adjacent cells (i.e., monitoring signal quality of adjacent cells), and, according to an algorithm of cell re-selection, switch to another cell if needed; and

2, monitor information from a paging channel.

It is found by the applicant that, in cases that an existing dual-card-dual-standby mobile phone is in a standby mode, protocol stacks of two SIM cards are time-sharing and operates independently from each other. That is, in each discontinuous reception (DRX) cycle, modem modules in connection with the two SIM cards complete the same mentioned work. In such case, in performing search of adjacent cells, some work processes are repeated, which causes extra amount of power consumption.

In the standby mode, the two SIM cards operate individually on different time-slots. It is assumed that in a discontinuous reception cycle, the first SIM card SIM1 operates on a time-slot 0 and the second SIM card SIM2 operates on a time-slot 1. Firstly, on the time-slot 0, the first SIM card SIM1 remains in a cell A and receives an adjacent cell control channel allocation list via a broadcast control channel (i.e. BAlist). The adjacent cell control channel allocation list includes the available channel information of adjacent cells, for example a frequency point. Signal strength of channels controlled by respective adjacent cells in the allocation list is measured according to the channel information of the adjacent cells, and the adjacent cells are sorted out according to the signal strength. In a similar way, on the time-slot 1, the second SIM card SIM2 remains in a cell X (according to information of the carrier, X may be the same as A or different from A), receives an adjacent cell control channel allocation list via a broadcast control channel, measures signal strength of channels controlled by respective adjacent cells in the allocation list according to the channel information of adjacent cells, and sort out the adjacent cells according to the signal strength.

During the standby, the dual-card-dual-standby mobile phone periodically turns on the modem to synchronize with the network and receive information from the broadcast channel, thereby completing search of adjacent cells. A whole standby (also referred to as an idle state) cycle includes two processes: a sleep process and a wakeup process. In the two processes, currents of which are different, and a standby current is an average value of the two. The standby current in the application refers to the average current.

Taking the dual-card-dual-standby mobile phone being dominant in the market as an example, configuration of a network mode used by the first SIM card is: 3G/4G+2G (supporting both the voice call service and the packet service), and configuration of a network mode used by the second SIM card is 2G (only supporting the voice call service). For conciseness, “a module associated with the first SIM card SIM1” is referred to as “SIM1” for short, and “a module associated with the second SIM card SIM2” is referred to as “SIM2” for short.

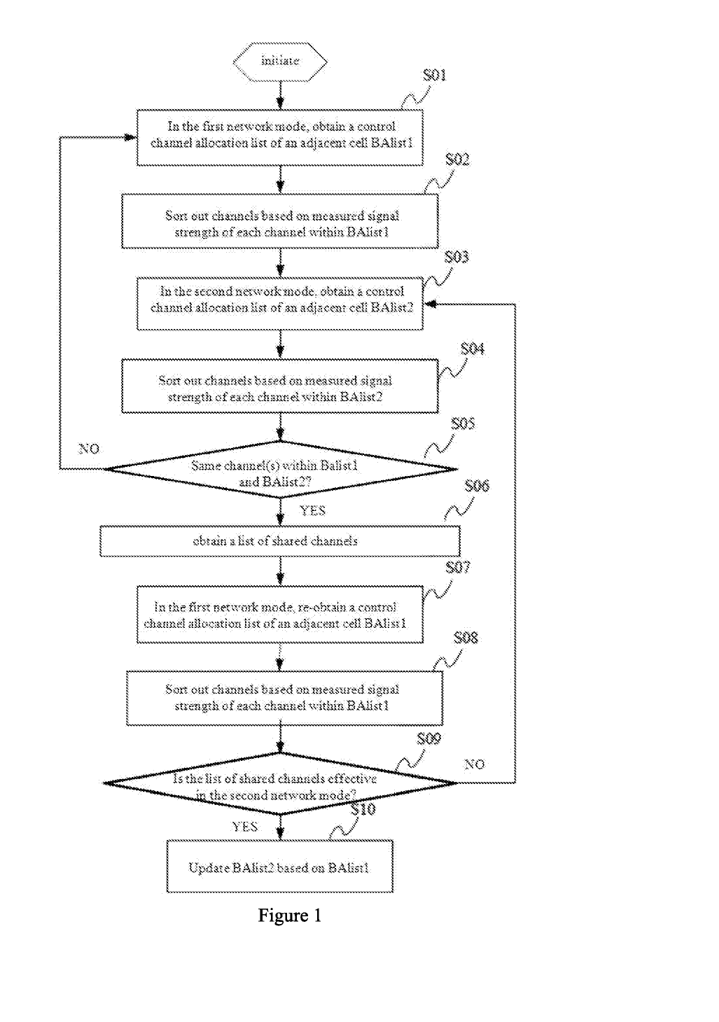

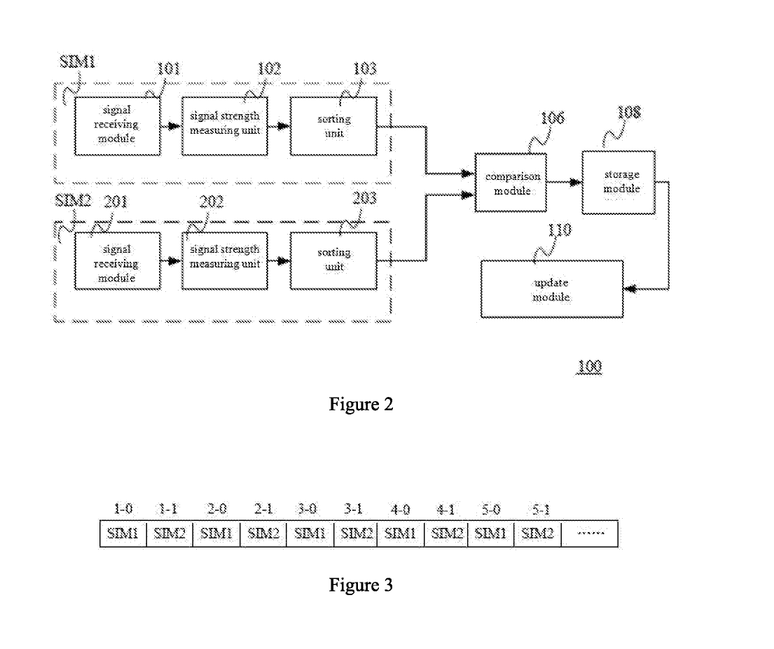

FIG. 1 is a flowchart of a method for controlling standby power consumption in accordance with an embodiment of the disclosure; FIG. 2 is a block diagram of principles of a device for controlling standby power consumption in accordance with an embodiment of the disclosure, and FIG. 3 is a schematic diagram in which a first SIM card and a second SIM card operate on different time-slots. A control device and a control method according to the embodiment are elaborated in detail in conjunction with FIG. 1, FIG. 2 and FIG. 3.

The control device 100 includes network modules SIM1 and SIM2 respectively associated with a first network mode and a second network mode, a comparison module 106, a storage module 108 and an update module 110. The network modules SIM1 and SIM2 obtain adjacent cell channel lists and signal strength information respectively in the first network mode and the second network mode. The comparison module 106 is configured to compare adjacent cell channel lists in the first network mode and the second network mode, and use multiple channels having the same frequency point in the two adjacent cell channel lists as shared channels according to the result of comparison. The storage module 108 is configured to store the list of shared channels. The update module 110 is configured to update the adjacent cell channel list in the second network mode according to the adjacent cell channel list in the first network mode.

The network module SIM1 includes a signal receiving unit 101, a signal strength measuring unit 102 and a sorting unit 103; and the network module SIM2 includes a signal receiving unit 201, a signal strength measuring unit 202 and a sorting unit 203, as shown in FIG. 2.

For example, where the mobile terminal is a mobile phone, the mobile phone includes an application processor, a memory, a modem and a radio frequency part. The radio frequency part includes a transceiver, an antenna and a filter, being adapted to the first network mode and the second network mode. The above-mentioned network module SIM1 and SIM2 may individually adopt modems, radio frequency parts and filters as respective receiving units, adopt a common application processor as respective signal strength measuring units and sorting units, adopt a common application processor as a comparison module and an update module, and adopt a common memory as a storage module.

In each discontinuous cycle, the SIM1 operates on a time-slot 0 and the SIM2 operates on a time-slot 1. Time-slots 0 and 1 of the first cycle of discontinuous reception are indicated respectively as a time-slot 1-0 and a time-slot 1-1, time-slots 0 and 1 of the second cycle of discontinuous reception are indicated respectively as a time-slot 2-0 and a time-slot 2-1, and so on, as shown in FIG. 3.

In the flowchart shown in FIG. 1, as an example, step S01 to step S04 are performed on the time-slots 1-0 and 1-1 of the first cycle of discontinuous reception.

On the time-slot 1-0, the SIM1 remains in a cell A, and performs step S01 and step S02.

In step S01, the signal receiving unit 101 of the SIM1 receives adjacent cell control channel data via a broadcast control channel, thereby obtaining an adjacent cell control channel allocation list 1 (referred to as BAlist1 for short).

In step S02, the signal strength measuring unit 102 of the SIM1 measures signal strength of all channels in the BAlist1, i.e., obtaining signal strength data of all the channels. The sorting unit 103 sorts out channels listed in the BAlist1 according to the signal strength.

In an example, adjacent cell channels and signal strength data thereof obtained by the SIM1 in step S01 and step S02 are: channel 512, −80 dbm; ch698, −95 dbm; ch1023, −101 dbm.

In the time-slot 1-1, the SIM2 remains in a cell X (according to the information of the carrier, X may be the same as or different from A), and performs step S03 and step S04.

In step S03, the signal receiving unit 201 of the SIM2 receives adjacent cell control channel data via a broadcast control channel, thereby obtaining an adjacent cell control channel allocation list 2 (referred to as BAlist2 for short).

In step S04, the signal strength measuring unit 202 of the SIM2 measures signal strength of all channels in the BAlist2, i.e., obtaining signal strength data of all the channels. The sorting unit 203 sort out the channels listed in the BAlist2 according to the signal strength.

In an embodiment, adjacent cell channels and signal strength data thereof obtained by the SIM2 in step S03 and step S04 are: ch1023, −101 dbm; ch125, −70 dbm, ch170, −80 dbm.

In the flowchart shown in FIG. 1, as an example, between the first cycle of discontinuous reception and the second cycle of discontinuous reception, step S05 and step S06 are performed.

In step S05, the comparison module 106 compares the adjacent cell channel lists BAlist1 and BAlist2 obtained on the two time-slots of the first cycle of discontinuous reception for frequency points.

If the comparison result for frequency points indicates that there is no same channel between the BAlist1 and the BAlist2, step S01 to step S05 are repeated in a subsequent discontinuous cycle. That is, in each discontinuous period, the SIM1 and SIM2 each start the signal receiving unit and attempt to reduce standby power consumption by utilizing the list of shared channels in the subsequent discontinuous work cycle. Alternatively, in the subsequent discontinuous cycle, only step S01 to step S04 may be repeated. That is, where no shared channel list is found in initialization, the SIM1 and the SIM2 each start the signal receiving unit in a subsequent work time period, and do not attempt to reduce standby power consumption.

If the comparison result for frequency points indicates that there are channels shared between the BAlist1 and the BAlist2, multiple channels having the same frequency points in the two adjacent cell channel lists are used as shared channels. Step S06 is further performed, and the storage module 108 stores lists, including the list of shared channels.

In an embodiment, in a case of the above-mentioned BAlist1 and BAlist2, the list of shared channels, which is obtained in step S05, includes one shared channel: ch1023. However, if carriers of the two SIM cards are the same, BAlist1 and BAlist2 may be completely the same, therefore BAlist1, BAlist2 and the list of shared channels are the same.

In the flowchart shown in FIG. 1, as an example, step S07 to step S10 are performed on the time-slots 2-0 and 2-1 of the second cycle of discontinuous reception.

On the time-slot 2-0, the SIM1 remains in a cell A and performs step S07 to step S09.

In step S07, the signal receiving unit 101 of the SIM1 receives adjacent cell control channel data via a broadcast control channel, thereby obtaining an adjacent cell control channel allocation list 1 (referred to as BAlist1 for short).

In step S08, the signal strength measuring unit 102 of the SIM1 measures signal strength of all channels in the BAlist1, i.e. re-obtaining signal strength data for all the channels. The sorting unit 103 sort out the channel listed in the BAlist1 according to the signal strength.

In an embodiment, adjacent cell channels and signal strength data thereof obtained by the SIM1 in step S07 and S08 are: ch1023, −56 dbm; channel 512, −87 dbm; ch698, −102 dbm. That is, in the embodiment, frequency points of channels of SIM1 in the BAlist1 s obtained in the first discontinuous cycle and the second discontinuous cycle are the same, signal strength changes and the sorting result changes. The channel ch1023 is a channel of the maximum signal strength among all channels.

In step S09, the SIM1 determines whether the list of shared channels is effective according to its BAlist1. If the list of shared channels is ineffective, step S03 to step S09 are performed, that is, in each discontinuous cycle, the SIM1 and the SIM2 each start the signal receiving unit and attempt to reduce standby power consumption by utilizing the list of shared channels in a subsequent discontinuous cycle. Alternatively, in the subsequent discontinuous cycle, only step S01 to step S04 may be repeated, that is, in a case that the list of shared channels is ineffective, in the subsequent cycle, the SIM1 and SIM2 each start the signal receiving unit without attempting to reduce standby power consumption.

In order to determine whether the list of shared channels is effective, the SIM1 follows at least one shared channel from the list of shared channels (can optionally follow 1 to 3 shared channel(s)). If the BAlist1 of the SIM1 has changed in the second discontinuous cycle, such that the BAlist1 does not include the at least one shared channel from the list of shared channels or a signal strength of the at least one shared channel is less than a threshold for triggering cell reselection, it is determined that the list of shared channels becomes ineffective; and in a subsequent step, the signal receiving unit is to be started, and the SIM2 needs to search channels again in order to update the BAlist2. Otherwise, the list of shared channels is deemed to be still effective; and in a subsequent step, is not necessary for the SIM2 to search for any effective channels again.

In the embodiment, the SIM1 follows the channel ch1023 from the list of shared channels. It is assumed that the threshold value of signal strength is −80 dbm. In the second discontinuous cycle, the BAlist1 obtained by the SIM2 includes this channel. In addition, the signal strength of the channel is −56 dbm, which is higher than the threshold value of −80 dbm. It follows that, the list of shared channels is still effective during the second discontinuous cycle.

If it is determined in step S09 that the list of shared channels is effective, the SIM2 performs step S10 on the time-slot 2-1. In such step, the SIM2 can update the BAlist2 according to the BAlist1 of the SIM1 without initiating the signal receiving unit.

If the BAlist2 and the list of shared channels are completely the same, for all the channels in the BAlist2, the SIM2 may not start the signal receiving unit and obtain frequency points of all adjacent cell channels and signal strength thereof directly according to the BAlist1 of the SIM1. If the list of shared channels only includes some channels from the BAlist2, for those channels, the SIM2 may obtain frequency points of those channels and signal strength thereof according to the BAlist1 of the SIM1.

In a case that step S10 is performed and after it is initialized, the SIM2 may avoid starting or reduce the number of times of starting the signal receiving unit in each of the subsequent discontinuous cycles, thereby reducing standby power consumption of the whole mobile terminal.

By adopting such method, repeated tasks of the SIM2 or the SIM1 in a standby state are consolidated, such that the dual-card-dual-standby mobile terminal in the embodiment can save part of standby current consumed by searching adjacent cells. Particularly where the carriers of the two networks are the same, the effect of controlling standby power consumption according to the present application is more significant.

In the above embodiment, the SIM1 determines whether the list of shared channels is effective by tracking one channel from the list of shared channels. In an alternative embodiment, the SIM1 may track three selected channels with the highest signal strength from the list of shared channels. If signal strength of each of the three channels is less than the threshold value, it indicates that signals of the three channels are not good enough and fail to meet the requirement, hence it can be determined that the list of shared channels is ineffective on the time-slot 2-1 of the SIM2. Hence, the SIM2 needs to search afresh on the time-slot 2-1. Otherwise, if signal strength of at least one channel is greater than the threshold value, it is indicates that the signal strength of the channel is powerful enough and switching of the cell or the channel will not be necessary, hence channel data in the list of shared channels can be directly shared with the SIM2.

In the above embodiment, where the list of shared channels is effective, for the channels from the list of shared channels, the SIM2 updates at least part of channels in the BAlist2 of the SIM2 according to the BAlist1 of the SIM1. In an alternative embodiment, where the list of shared channels is effective, the SIM2 directly uses the list of shared channels as the BAlist2 and updates the BAlist2 according to the signal strength of the channels in the BAlist1. That is, if the list of shared channels only includes part of channels in the BAlist2, the SIM2 may update the BAlist2 according to the BAlist1 of the SIM1 without initiating the signal receiving unit, as long as it is ensured that the SIM2 can operate in a channel of required signal strength.

In the present application, power can be saved by reducing number of times of searching cells performed in one network mode. It makes more sense if the SIM1 and the SIM2 are from the same carrier, where the adjacent cell lists are completely the same, work flows of the SIM1 and the SIM2 can be integrated into one.

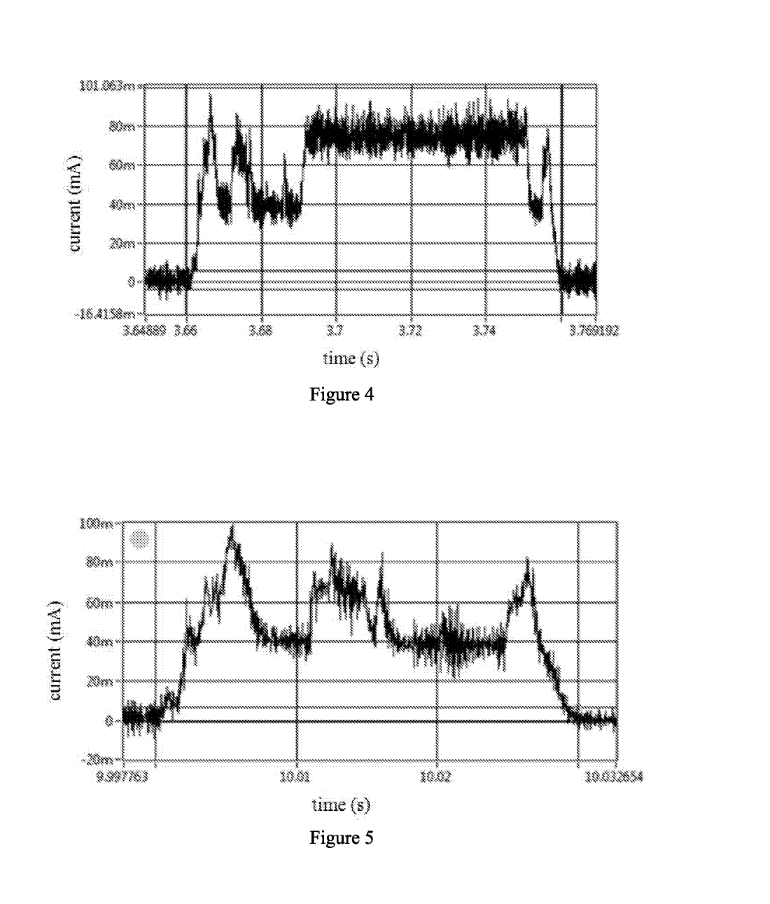

FIG. 4 and FIG. 5 show a current waveform graph of a method for controlling standby power consumption of a mobile terminal according to the prior art and an embodiment of the disclosure respectively, during a wakeup cycle of a second SIM card. In the embodiment, the second SIM card is a SIM card supporting a GSM network mode, for example.

As an example for comparison, a mobile terminal initiates a signal receiving unit to perform adjacent cell search in a GSM standby time-slot, as shown in FIG. 4. In an embodiment of the disclosure, the mobile terminal performs adjacent cell search in the GSM standby time-slot without initiating the signal receiving unit. At the location of the battery connector, different current waveforms with respect to two control methods are measured. In FIG. 4 and FIG. 5, a horizontal axis indicates time and a vertical axis indicates magnitude of the current.

As shown in FIG. 4, if adjacent cell search is performed, a modem and a radio frequency part are waked up for 100 ms, and current of the battery is about 80 mA. By contrast, as shown in FIG. 5, if no adjacent cell search is performed, the wakeup time cycle is only 30 ms and current is 40-60 mA. It follows that combining of searches of adjacent cells of the two SIM cards can significantly optimize the average current of the mobile phone in the standby state.

A non-transitory computer-readable storage medium, wherein the said non-transitory computer-readable storage medium can store computer-executable instructions, is provided according to an embodiment of the present disclosure, and the said computer-executable instructions are configured to execute any one of the said methods of embodiments of the present application for controlling standby power consumption of a mobile terminal.

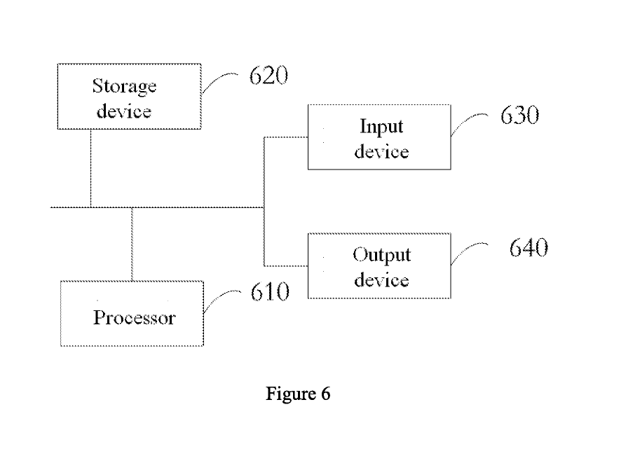

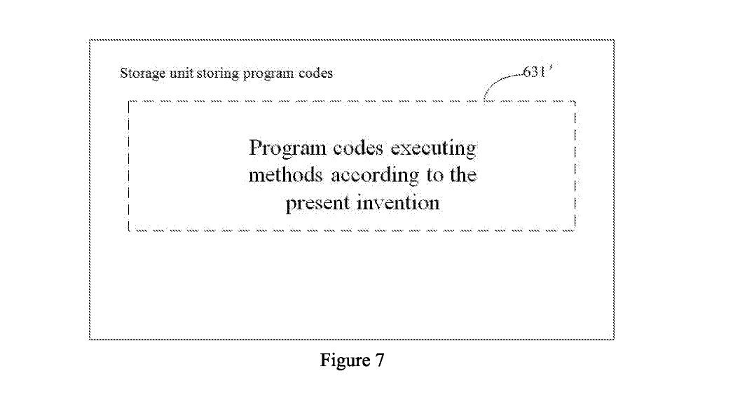

FIG. 6 illustrates the hardware structure of the device executing the method of controlling standby power consumption of mobile terminal prescribed by the present invention. As shown in FIG. 6, the said device comprises:

at least one processor 610 which is shown in FIG. 6 as an example, and a storage device 620;

the device executing the controlling standby power consumption of a mobile terminal method further comprises: an input device 630 and an output device 640;

processor 610, storage device 620, input device 630 and output device 640 can be connected by BUS or other methods, and BUS connecting is showed in FIG. 6 as an example.

Storage device 620 can be used for storing non-transitory software program, non-transitory computer executable program and modules as a non-transitory computer-readable storage medium, such as corresponding program instructions/modules for the methods for controlling standby power consumption of a mobile terminal mentioned by embodiments of the present disclosure. Processor 610 by executing non-transitory software program performs all kinds of functions of a server and process data, instructions and modules which are stored in storage device 620, thereby realizes the methods mentioned by embodiments of the present disclosure.

Storage device 620 can include program storage area and data storage area, thereby the operating system and applications required by at least one function can be stored in program storage area and data created by using the device for controlling standby power consumption of a mobile terminal can be stored in data storage area. Furthermore, storage device 620 can include high speed Random-access memory (RAM) or non-volatile memory such as hard drive storage device, flash memory device or other non-volatile solid state storage devices. In some embodiments, storage device 620 can include long-distance setup memories relative to processor 610, which can communicate via network with the device for realizing the methods mentioned by embodiments of the present disclosure. The examples of said networks are including but not limited to Internet, Intranet, LAN, mobile Internet and their combinations.

Input device 630 can be used to receive inputted number, character information and key signals causing user configures and function controls of the device. Output device 640 can include a display screen or a display device.

The said module or modules are stored in storage device 620 and perform any one of the methods for controlling standby power consumption of a mobile terminal when executed by one or more processors 610.

The said device can achieve the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-16 (canceled)

17. A method for controlling standby power consumption of a mobile terminal, wherein the said mobile terminal operates in a first network mode and a second network mode, and the said method comprises:
in a first cycle of discontinuous reception, obtaining, by way of searching adjacent cells, a control channel allocation list of a first adjacent cell for the first network mode and a control channel allocation list of a second adjacent cell for the second network mode;
generating a list of shared channels according to the same channels within the said control channel allocation list of the first adjacent cell and the said control channel allocation list of the second adjacent cell; and
in a second cycle of discontinuous reception, re-obtaining, by way of searching adjacent cells, the said control channel allocation list of the first adjacent cell and updating the said control channel allocation list of the second adjacent cell according to the said control channel allocation list of the first adjacent cell.

18. The method according to claim 17, wherein the said first cycle of discontinuous reception includes a first time-slot and a second time-slot, and the said control channel allocation list of the first adjacent cell and the said control channel allocation list of the second adjacent cell are obtained respectively on the said first time-slot and the said second time-slot of the said first cycle of discontinuous reception,
and wherein the said second cycle of discontinuous reception includes a first time-slot and a second time-slot, and the said control channel allocation list of the first adjacent cell is re-obtained on the first time-slot of the said second cycle of discontinuous reception and the said control channel allocation list of the second adjacent cell is updated on the second time-slot of the said second cycle of discontinuous reception.

19. The method according to claim 17, wherein
in the said first cycle of discontinuous reception, it further comprises:
measuring signal strength of multiple channels in the said first adjacent cell control channel and sorting out the multiple channels in the said first adjacent cell control channel according to the signal strength; and
measuring signal strength of multiple channels in the said second adjacent cell control channel and sorting out the multiple channels in the said second adjacent cell control channel according to the signal strength,
and wherein, in the said second cycle of discontinuous reception, it further comprises:
re-measuring signal strength of multiple channels in the said first adjacent cell control channel and sorting out the multiple channels in the said first adjacent cell control channel according to the signal strength.

20. The method according to claim 17, wherein the updating the said control channel allocation list of the second adjacent cell according to the said control channel allocation list of the first adjacent cell comprises:
where the said list of shared channels is effective, updating, in the said second cycle of discontinuous reception, the said control channel allocation list of the second adjacent cell by using the channel information of the said control channel allocation list of the first adjacent cell; and
where the said list of shared channels is ineffective, re-obtaining, in the said second cycle of discontinuous reception, the said control channel allocation list of the second adjacent cell by searching adjacent cells.

21. The method according to claim 20, wherein the updating the said control channel allocation list of the second adjacent cell according to the said control channel allocation list of the first adjacent cell further comprises:
measuring signal strength of multiple channels in the said first adjacent cell control channel and sorting out the said multiple channels in the said first adjacent cell control channel according to the signal strength; and
determining whether the said list of shared channels is effective according to the re-obtained said control channel allocation list of the said first adjacent cell and the measured signal strength.

22. The method according to claim 21, wherein the determining whether the said list of shared channels is effective comprises:
comparing the said re-obtained first adjacent cell control channel with the said list of shared channels; and
comparing the said measured signal strength with a predetermined threshold value,
wherein the said list of shared channels is determined to be effective if the said re-obtained control channel allocation list of the first adjacent cell includes a shared channel from the said list of shared channels and signal strength of at least one shared channel from the said shared channels is greater than the said predetermined threshold value.

23. The method according to claim 22, wherein the updating the said control channel allocation list of the second adjacent cell according to the said control channel allocation list of the first adjacent cell comprises:
using the said list of shared channels as the said control channel allocation list of the second adjacent cell.

24. The method according to claim 22, wherein the updating the said control channel allocation list of the second adjacent cell according to the said control channel allocation list of the first adjacent cell comprises:
updating, for at least one of the said shared channels, information of the corresponding channels in the said control channel allocation list of the second adjacent cell by using information of the at least one of the said shared channels.

25. The method according to claim 17, wherein the said first network mode and the said second network mode are selected respectively from 2G, 3G and 4G mobile communication networks.

26. The method according to claim 17, wherein the said first cycle of discontinuous reception and the said second cycle of discontinuous reception are standby cycles of the said mobile terminal.

27. An electronic device, comprising:
at least one processor; and
a storage device communicably connected with the said at least one processor; wherein,
the said storage device stores instructions executable by the said at least one processor, wherein execution of the instructions by the said at least one processor causes the at least one processor to:
in a first cycle of discontinuous reception, obtain, by way of searching adjacent cells, a control channel allocation list of a first adjacent cell for the first network mode and a control channel allocation list of a second adjacent cell for the second network mode;
generate a list of shared channels according to the same channels within the said control channel allocation list of the first adjacent cell and the said control channel allocation list of the second adjacent cell; and
in a second cycle of discontinuous reception, re-obtain, by way of searching adjacent cells, the said control channel allocation list of the first adjacent cell and update the said control channel allocation list of the second adjacent cell according to the said control channel allocation list of the first adjacent cell,
wherein the said electronic device operates in the said first network mode and the said second network mode.

28. The electronic device according to claim 27, wherein the said first cycle of discontinuous reception includes a first time-slot and a second time-slot, and the said control channel allocation list of the first adjacent cell and the said control channel allocation list of the second adjacent cell are obtained respectively on the said first time-slot and the said second time-slot of the said first cycle of discontinuous reception,
and wherein the said second cycle of discontinuous reception includes a first time-slot and a second time-slot, and the said control channel allocation list of the first adjacent cell is re-obtained on the first time-slot of the said second cycle of discontinuous reception and the said control channel allocation list of the second adjacent cell is updated on the second time-slot of the said second cycle of discontinuous reception.

29. The electronic device according to claim 27, wherein,
in the said first cycle of discontinuous reception, it further comprises:
measuring signal strength of multiple channels in the said first adjacent cell control channel and sorting out the multiple channels in the said first adjacent cell control channel according to the signal strength; and
measuring signal strength of multiple channels in the said second adjacent cell control channel and sorting out the multiple channels in the said second adjacent cell control channel according to the signal strength,
and wherein, in the said second cycle of discontinuous reception, it further comprises:
re-measuring signal strength of multiple channels in the said first adjacent cell control channel and sorting out the multiple channels in the said first adjacent cell control channel according to the signal strength.

30. The electronic device according to claim 27, wherein the updating the said control channel allocation list of the second adjacent cell according to the said control channel allocation list of the first adjacent cell comprises:
where the said list of shared channels is effective, updating, in the said second cycle of discontinuous reception, the said control channel allocation list of the second adjacent cell by using the channel information of the said control channel allocation list of the first adjacent cell; and
where the said list of shared channels is ineffective, re-obtaining, in the said second cycle of discontinuous reception, the said control channel allocation list of the second adjacent cell by searching adjacent cells.

31. The electronic device according to claim 27, wherein the updating the said control channel allocation list of the second adjacent cell according to the said control channel allocation list of the first adjacent cell further comprises:
measuring signal strength of multiple channels in the said first adjacent cell control channel and sorting out the said multiple channels in the said first adjacent cell control channel according to the signal strength; and
determining whether the said list of shared channels is effective according to the re-obtained said control channel allocation list of the said first adjacent cell and the measured signal strength.

32. The electronic device according to claim 31, wherein the determining whether the said list of shared channels is effective comprises:
comparing the said re-obtained first adjacent cell control channel with the said list of shared channels; and
comparing the said measured signal strength with a predetermined threshold value, wherein the said list of shared channels is determined to be effective if the said re-obtained control channel allocation list of the first adjacent cell includes a shared channel from the said list of shared channels and signal strength of at least one shared channel from the said shared channels is greater than the said predetermined threshold value.

33. The electronic device according to claim 32, wherein the updating the said control channel allocation list of the second adjacent cell according to the said control channel allocation list of the first adjacent cell comprises:
using the said list of shared channels as the said control channel allocation list of the second adjacent cell.

34. The electronic device according to claim 32, wherein the updating the said control channel allocation list of the second adjacent cell according to the said control channel allocation list of the first adjacent cell comprises:
updating, for at least one of the said shared channels, information of the corresponding channels in the said control channel allocation list of the second adjacent cell by using information of the at least one of the said shared channels.

35. The electronic device according to claim 27, wherein the said first cycle of discontinuous reception and the said second cycle of discontinuous reception are standby cycles of the said electronic device.

36. A non-transitory computer-readable storage medium, wherein the said non-transitory computer-readable storage medium can store computer-executable instructions, the said computer-executable instructions are used to:
in a first cycle of discontinuous reception, obtain, by way of searching adjacent cells, a control channel allocation list of a first adjacent cell for the first network mode and a control channel allocation list of a second adjacent cell for the second network mode;
generate a list of shared channels according to the same channels within the said control channel allocation list of the first adjacent cell and the said control channel allocation list of the second adjacent cell; and
in a second cycle of discontinuous reception, re-obtain, by way of searching adjacent cells, the said control channel allocation list of the first adjacent cell and update the said control channel allocation list of the second adjacent cell according to the said control channel allocation list of the first adjacent cell,
wherein the said non-transitory computer-readable storage medium operates in the said first network mode and the said second network mode.
